(19) United States
(12) Patent Application Publication
(10) Pub. No.: US 2011/0093526 A1
(43) Pub. Date: Apr. 21, 2011

(54) CLOUD COMPUTING SYSTEM

(76) Inventor: YUNG-HO LIUE, TAIPEI CITY (TW)

(21) Appl. No.: 12/893,267

(22) Filed: Sep. 29, 2010

(30) Foreign Application Priority Data
Oct. 19, 2009 (TW) 98135234

(51) Int. Cl. G06F 15/16

(52) U.S. Cl. 709/203

(57) ABSTRACT

A cloud computing system includes a remote host, a portable computer comprising a display, a keyboard, a multiplex IC interface, a register interface, a network card interface and a display interface and linked to the remote hole through the internet when started up. When an array of signals are inputted into the portable computer by means of the keyboard, the inputted data is transmitted by the multiplex IC interface to the register interface and then transmitted through the network card interface to the remote host via the internet, and the data that is transmitted by the portable computer to the remote host through the internet is then computed by the remote host, and then the remote host transmits the processed data through the internet back to the portable computer, enabling the processed text and/or graphic data to be displayed on the display by the display interface.

### BACKGROUND OF THE INVENTION

1. Field of the Invention

The present invention relates to computer technology and more particularly, to the application of a cloud computing system, in which, the portable computer comprises a display, a keyboard, a multiplex IC interface, a register interface, a (wired or wireless) network card interface and a display interface, eliminating the use of a motherboard, a hard disk drive, a CD-ROM and a floppy disk drive that are commonly used in a conventional portable computer. Thus, the cloud computing system minimizes the weight and dimension of the portable computer and saves its power consumption.

2. Description of the Related Art

At the present time, energy is getting short, and the over discharge of carbon dioxide gas makes the earth like a greenhouse, causing the global warming and damaging our planet's environment.

Nowadays, many countries are trying hard to reduce energy consumption and carbon dioxide gas discharge. In consequence, many power-saving green electric and electronic products are created.

Further, following the step of the development of high technology, computer has become a requisite tool in every family. For the advantage of high mobility, portable computers (notebook computers) are highly invited. A regular portable computer generally comprises a motherboard carrying a CPU for processing data (see FIG. 6). However, the CPU consumes much power and releases much waste heat during operation. An advanced CPU provides a relatively higher operating speed, however it consumes a relatively higher amount of power supply. In addition to the motherboard, a portable computer further comprises a display, a keyboard, a multiplex IC interface, a register interface, a (wired or wireless) network card interface, a display interface, a hard disk drive, a CD-ROM, a floppy disk drive, and other component parts. Due to the arrangement of the aforesaid multiple component parts, conventional portable computers are still heavy and require much power supply during operation.

Therefore, it is desirable to provide a measure that eliminates the drawbacks of high power consumption and heavy weight of conventional portable computers.

### SUMMARY OF THE INVENTION

The present invention has been accomplished under the circumstances in view. It is the main object of the present invention to provide a cloud computing system, which minimizes the weight and dimension of a portable computer and saves its power consumption.

To achieve this and other objects of the present invention, a cloud computing system comprises a remote host having a CPU at a circuit board thereof for processing data, a portable computer linkable to the remote host through the internet, the portable computer comprising a display for display data, a keyboard having a plurality of keys for data input, a multiplex IC interface, a register interface, a network card interface connected to the internet and a display interface electrically connected between the network card interface and the display, wherein when an array of signals are inputted into the portable computer by means of the keys of the keyboard, the inputted data is transmitted by the multiplex IC interface to the register interface and then transmitted through the network card interface to the remote host via the internet, and the data that is transmitted by the portable computer to the remote host through the internet is then computed by the remote host, and then the remote host transmits the processed data through the internet back to the portable computer, enabling the processed text and/or graphic data to be displayed on the display by the display interface.

Further, each key of the keyboard has corrugated peripheral edges. Each corrugated peripheral edge of each key matches one corrugated peripheral edge of one adjacent key. Thus, subject to the matching arrangement of the keys, the size of the keyboard is minimized.

### BRIEF DESCRIPTION OF THE DRAWINGS

FIG. 1 illustrates the basic architecture of a cloud computing system in accordance with the present invention.

FIG. 2 is a schematic front plain view of a part of the keyboard of the cloud computing system in accordance with the present invention.

FIG. 3 is a sectional view, in an enlarged scale, of a part of the keyboard of the cloud computing system in accordance with the present invention.

FIG. 4 corresponds to FIG. 3, illustrating the key pressed, the metal conductive end block touched the associating switch contact set at the circuit board.

FIG. 5 is a schematic drawing of the present invention, illustrating the metal conductive end block of one pressed key touched the associating switch contact set at the circuit board and one adjacent key accidentally pressed and tilted.

FIG. 6 is an elevational view of a conventional portable computer.

### DETAILED DESCRIPTION OF THE PREFERRED EMBODIMENT

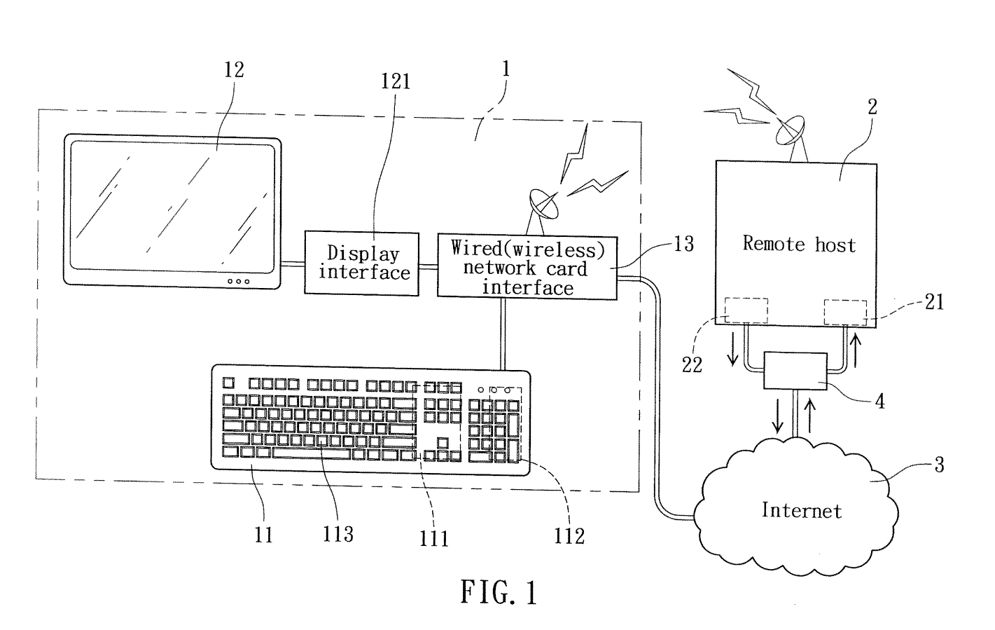

Referring to FIG. 1, a cloud computing system in accordance with the present invention is shown comprising a portable computer 1 linkable to a remote host 2 through the internet 3. The portable computer 1 comprises a display 12, a keyboard 11, a multiplex IC interface 111, a register interface 112, a (wired or wireless) network card interface 13 and a display interface 121. Unlike a conventional portable computer, the portable computer 1 eliminates motherboard, hard disk drive, CD-Rom, floppy disk drive. When an array of signals are inputted into the portable computer 1 by means of the keys 113 of the keyboard 11, the signals are transmitted by the multiplex IC interface 111 to the register interface 112 and then transmitted through the (wired or wireless) network card interface 13 to the remote host 2 via the internet 3. The data that is transmitted by the portable computer 1 to the remote host 2 through the internet 3 is then computed by the remote host 2, and then the remote host 2 transmits the processed data through the internet 3 back to the portable computer 1, enabling the processed text and/or graphic data to be displayed on the display 12 by the display interface 121. Further, a processor 4 is connected between the internet 3 and the input port 21 and output port 22 of the remote host 2, and adapted for transmitting the data provided by the portable computer 1 to the internet 3 to the input port 21 of the remote host 2 for processing by the CPU at the motherboard of the remote host 2 and then transmitting the processed data from the output port 22 of the remote host 2 to the internet 3 and then the network card interface 13 of the portable computer 1. Therefore, the portable computer 1 is immediately linked to the remote host 2 when started up. This linking arrangement allows the portable computer 1 to access to data storage means, for example, hard disk drive of the remote host 2. Because the portable computer 1 eliminates motherboard, hard disk drive, CD-Rom and floppy disk drive, the portable computer 1 consumes less power supply, and the weight and dimension of the portable computer 1 can be minimized.

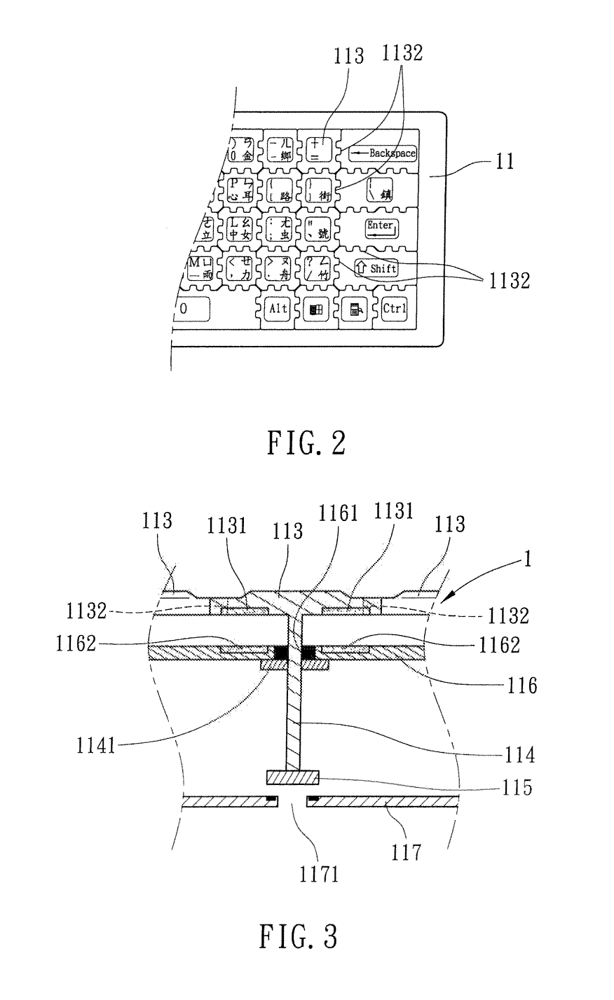

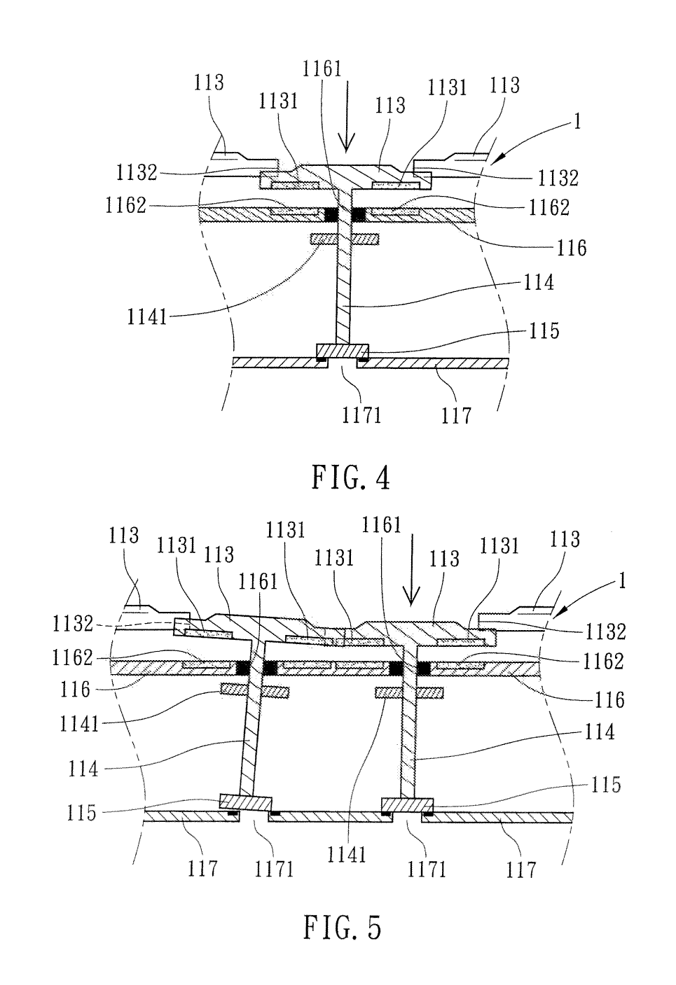

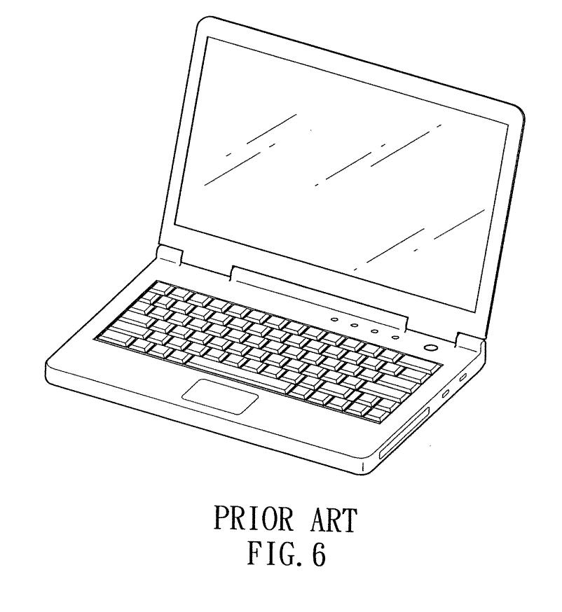

Referring to FIG. 2, each key 113 of the keyboard 11 has corrugated peripheral edges 1132. Each corrugated peripheral edge 1132 of each key 113 matches one corrugated peripheral edge 1132 of one adjacent key 113 without interfering with the operation of every individual key 113.

Referring to FIGS. 3˜5, the keyboard 11 comprises a circuit board 117 having multiple switch contact sets 1171, and a partition frame 116 suspending above the circuit board 117 below the keys 113. The partition frame 116 has a plurality of through holes 1161 corresponding to the switch contact sets 1171, and a plurality of magnets 1162 mounted therein around each through hole 1161. Each key 113 comprises a bottom shank 114 vertically downwardly extended from the bottom wall thereof and inserted through one through hole 1161 of the partition frame 116, a metal conductive end block 115 located on the bottom end of the bottom shank 114 and adapted for touching and switching on one respective switch contact set 1171 of the circuit board 117, a stop flange 1141 extending around the periphery of the bottom shank 114 at a selected location below the partition frame 116 and adapted to limit the upward stroke of the bottom shank 114, and a magnet 1131 located on the bottom wall thereof around the bottom shank 114 and adapted for producing a magnetic expelling force against the magnet 1162 in the partition frame 116 around the corresponding through hole 1161. When the user presses one key 113 to overcome the magnetic expelling force between the respective magnets 1131; 1162, the metal conductive end block 115 of the bottom shank 114 of the key 113 is lowered to touch and switch on the associating switch contact set 1171 of the circuit board 117, causing the circuit board 117 to output a corresponding switch signal. When the user released the finger from the key 113, the magnetic expelling force between the respective magnets 1131; 1162 immediately returns the key 113 to its former position, and the metal conductive end block 115 of the bottom shank 114 of the key 113 is moved away from the associating switch contact set 1171 of the circuit board 117. Further, if one peripheral edge of one adjacent key 113 is accidentally pressed when the user is pressing one key 113, the adjacent key 113 will be tilted, preventing the metal conductive end block 115 of the bottom shank 114 of the adjacent key 113 from switching on the associating switch contact set 1171 of the circuit board 117 (see FIG. 5).

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A cloud computing system, comprising a remote host having a CPU at a circuit board thereof for processing data, a portable computer linkable to said remote host through the internet, said portable computer comprising a display for display data, a keyboard having a plurality of keys for data input, a multiplex IC interface, a register interface, a network card interface connected to the internet and a display interface electrically connected between said network card interface and said display, wherein when an array of signals are inputted into said portable computer by means of the keys of said keyboard, the inputted data is transmitted by said multiplex IC interface to said register interface and then transmitted through said network card interface to said remote host via the internet, and the data that is transmitted by said portable computer to said remote host through the internet is then computed by said remote host, and then said remote host transmits the processed data through the internet back to said portable computer, enabling the processed text and/or graphic data to be displayed on said display by said display interface.

2. The cloud computing system as claimed in claim 1, wherein said remote host comprises data storage means for storing data; said portable computer is accessible to storage data in said data storage means of said remote host through the internet.

3. The cloud computing system as claimed in claim 1, wherein each key of said keyboard has corrugated peripheral edges, each corrugated peripheral edge of each said key matches one corrugated peripheral edge of one adjacent said key.

4. The cloud computing system as claimed in claim 1, wherein said keyboard further comprises a circuit board disposed at a bottom side thereof and a partition frame suspending above said circuit board below said keys, said circuit board comprising multiple switch contact sets, said partition frame comprising a plurality of through holes respectively disposed corresponding to said switch contact sets and a plurality of magnets mounted therein around each said through hole; each said key comprises a bottom shank vertically downwardly extended from a bottom wall thereof and inserted through one said through hole of said partition frame, a metal conductive end block located on a bottom end of said bottom shank and adapted for touching and switching on one said switch contact set of said circuit board and a magnet located on the bottom wall thereof around said bottom shank and adapted for producing a magnetic expelling force against the magnet in said partition frame around the associating through hole.

5. The cloud computing system as claimed in claim 1, further comprising a processor connected between the internet and an input port and an output port of said remote host and adapted for transmitting the data provided by said portable computer to the input port of said remote host through the internet for processing by the CPU of the motherboard of said remote host and then transmitting the processed data from the output port of said remote host to the internet and then said network card interface of said portable computer.

6. The cloud computing system as claimed in claim 4, wherein each said key further comprises a stop flange extending around the periphery of the bottom shank thereof at a selected location below said partition frame and above said circuit board and adapted to limit the upward stroke of the associating bottom shank.
